(19) United States
(12) Patent Application Publication
(10) Pub. No.: US 2008/0123997 A1
(43) Pub. Date: May 29, 2008

(54) PROVIDING A DESIRED RESOLUTION COLOR IMAGE

(76) Inventors: James E. Adams, Rochester, NY (US); Michele O'Brien, Rochester, NY (US); John F. Hamilton, Rochester, NY (US)

Correspondence Address: Frank Pincelli;Patent Legal Staff, Eastman Kodak Company, 343 State Street, Rochester, NY, 14650-2201, US

(21) Appl. No.: 11/564,451

(22) Filed: Nov. 29, 2006

(51) Int. Cl. G06K 9/32

(52) U.S. Cl. 382/299

(57) ABSTRACT

A method for forming a digital color image of a desired resolution, includes providing a panchromatic image of a scene having a first resolution at least equal to the desired resolution and a first color image having at least two different color photoresponses, the first color image having a lower resolution than the desired resolution; and using the color pixel values from the first color image and the panchromatic pixel values to provide additional color pixels and combining the additional color pixels with the first color image to produce the digital color image having the desired resolution.

### CROSS REFERENCE TO RELATED APPLICATION

Reference is made to commonly assigned U.S. patent application Ser. No. 11/341,206, filed Jan. 27, 2006 by James E. Adams, Jr. et al, entitled “Interpolation of Panchromatic and Color Pixels”, the disclosure of which is incorporated herein.

### FIELD OF THE INVENTION

The present invention relates to forming a color image having a desired resolution from a panchromatic image and a color image having less than the desired resolution.

### BACKGROUND OF THE INVENTION

Video cameras and digital still cameras generally employ a single image sensor with a color filter array to record a scene. This approach begins with a sparsely populated single-channel image in which the color information is encoded by the color filter array pattern. Subsequent interpolation of the neighboring pixel values permits the reconstruction of a complete three-channel, full-color image. One popular approach is to either directly detect or synthesize a luminance color channel, e.g. “green”, and then to generate a full-resolution luminance image as an initial step. This luminance channel is then used in a variety of ways to interpolate the remaining color channels. A simple bilinear interpolation approach is disclosed in U.S. Pat. No. 5,506,619 (Adams et al.) and U.S. Pat. No. 6,654,492 (Sasai). Adaptive approaches using luminance gradients and laplacians are also taught in U.S. Pat. No. 5,506,619 as well as U.S. Pat. No. 5,629,734 (Hamilton et al.). U.S. Patent Application Publication No. 2002/0186309 (Keshet et al.) reveals using bilateral filtering of the luminance channel in a different kind of adaptive interpolation. Finally, U.S. Patent Application Publication No. 2003/0053684 (Acharya) describes using a bank of median filters on the luminance channel in yet another adaptive interpolation method.

Under low-light imaging situations, it is advantageous to have one or more of the pixels in the color filter array unfiltered, i.e. white or panchromatic in spectral sensitivity. These panchromatic pixels have the highest light sensitivity capability of the capture system. Employing panchromatic pixels represents a tradeoff in the capture system between light sensitivity and color spatial resolution. To this end, many four-color color filter array systems have been described. U.S. Pat. No. 6,529,239 (Dyck et al.) teaches a green-cyan-yellow-white pattern that is arranged as a 2×2 block that is tessellated over the surface of the sensor. U.S. Pat. No. 6,757,012 (Hubina et al.) discloses both a red-green-blue-white pattern and a yellow-cyan-magenta-white pattern. In both cases, the colors are arranged in a 2×2 block that is tessellated over the surface of the imager. The difficulty with such systems is that only one-quarter of the pixels in the color filter array have highest light sensitivity, thus limiting the overall low-light performance of the capture device.

To address the need of having more pixels with highest light sensitivity in the color filter array, U.S. Patent Application Publication No. 2003/0210332 (Frame) describes a pixel array with most of the pixels being unfiltered. Relatively few pixels are devoted to capturing color information from the scene producing a system with low color spatial resolution capability. Additionally, Frame teaches using simple linear interpolation techniques that are not responsive to or protective of high frequency color spatial details in the image.

### SUMMARY OF THE INVENTION

It is an object of the present invention to produce a digital color image having the desired resolution from a digital image having panchromatic and color pixels.

This object is achieved by a method for forming a digital color image of a desired resolution, comprising:

(a) providing a panchromatic image of a scene having a first resolution at least equal to the desired resolution and a first color image having at least two different color photoresponses, the first color image having a lower resolution than the desired resolution; and

(b) using the color pixel values from the first color image and the panchromatic pixel values to provide additional color pixels and combining the additional color pixels with the first color image to produce the digital color image having the desired resolution.

It is a feature of the present invention that images can be captured under low-light conditions with a sensor having panchromatic and color pixels and processing produces the desired resolution in a digital color image produced from the panchromatic and colored pixels.

The present invention makes use of a color filter array with an appropriate composition of panchromatic and color pixels in order to permit the above method to provide both improved low-light sensitivity and improved color spatial resolution fidelity. The above method preserves and enhances panchromatic and color spatial details and produce a full-color, full-resolution image.

### BRIEF DESCRIPTION OF THE DRAWINGS

FIG. 1 is a perspective of a computer system including a digital camera for implementing the present invention;

FIG. 2 is a block diagram of a preferred embodiment of the present invention;

FIG. 3 is a block diagram showing block 206 in FIG. 2 in more detail;

FIG. 4 is a block diagram showing block 206 in FIG. 2 in more detail of an alternate embodiment of the present invention;

FIG. 5 is a block diagram showing block 206 in FIG. 2 in more detail of an alternate embodiment of the present invention;

FIG. 6 is a block diagram showing block 206 in FIG. 2 in more detail of an alternate embodiment of the present invention;

FIG. 7 is a region of pixels used in block 206 in FIG. 2;

FIG. 8 is a region of pixels used in block 210 in FIG. 3; and

FIG. 9 is a region of pixels used in block 220 in FIG. 4.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

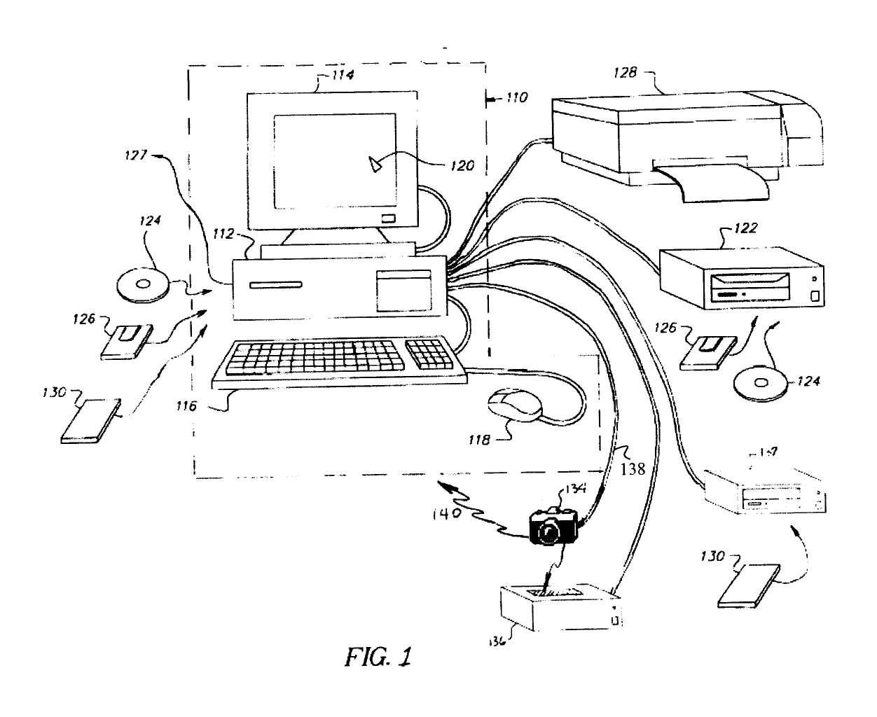

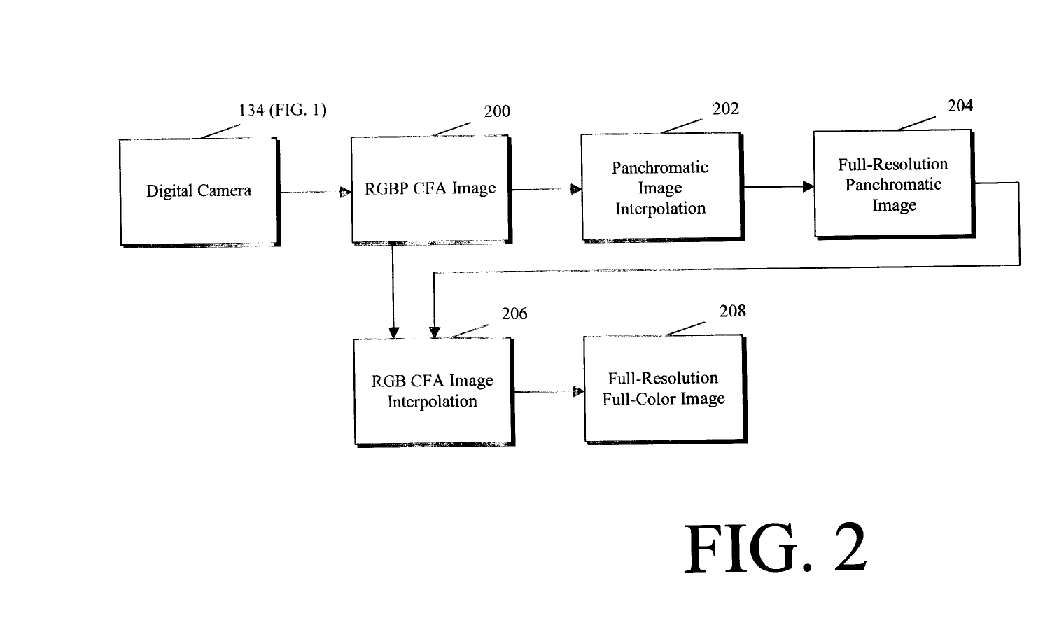

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a way of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as, as it was formerly known, a PCMCIA card (based on the specifications of the Personal Computer Memory Card International Association) which contains digitized images electronically embodied in the PC card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images can also be input via the compact disk 124, the floppy disk 126, or the network connection 127. Any images stored in the PC card 130, the floppy disk 126 or the compact disk 124, or input through the network connection 127, can have been obtained from a variety of sources, such as a digital camera (not shown) or a scanner (not shown). Images can also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm can be stored in any of the storage devices heretofore mentioned and applied to images in order to interpolate sparsely populated images.

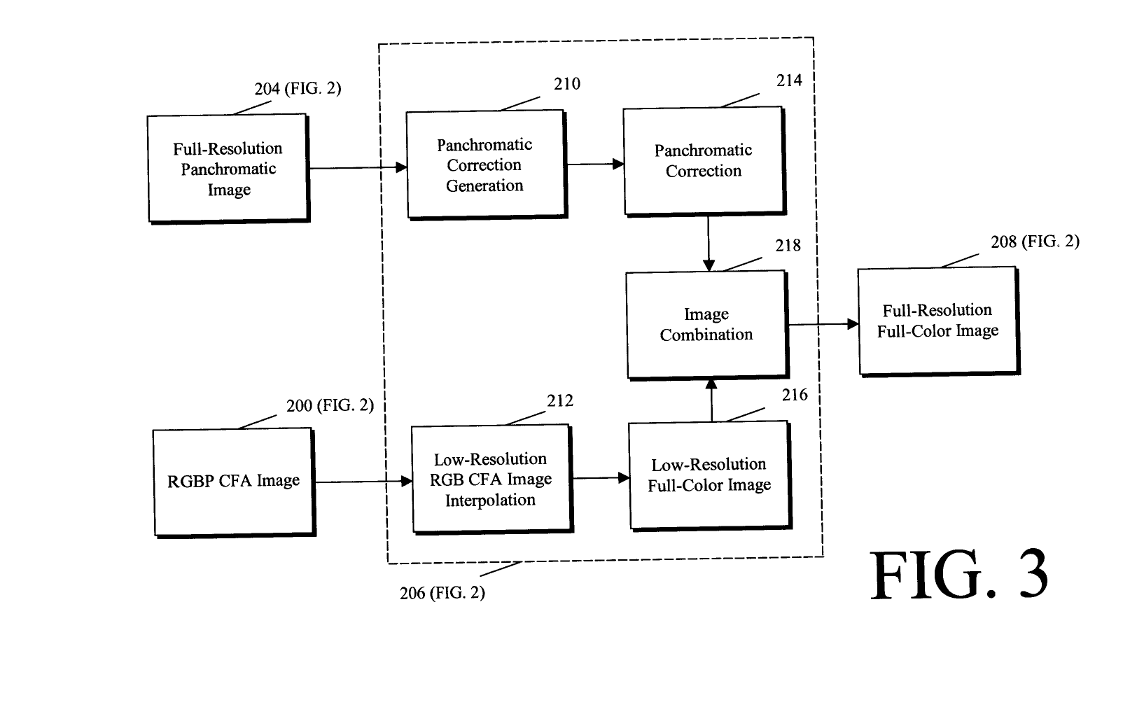

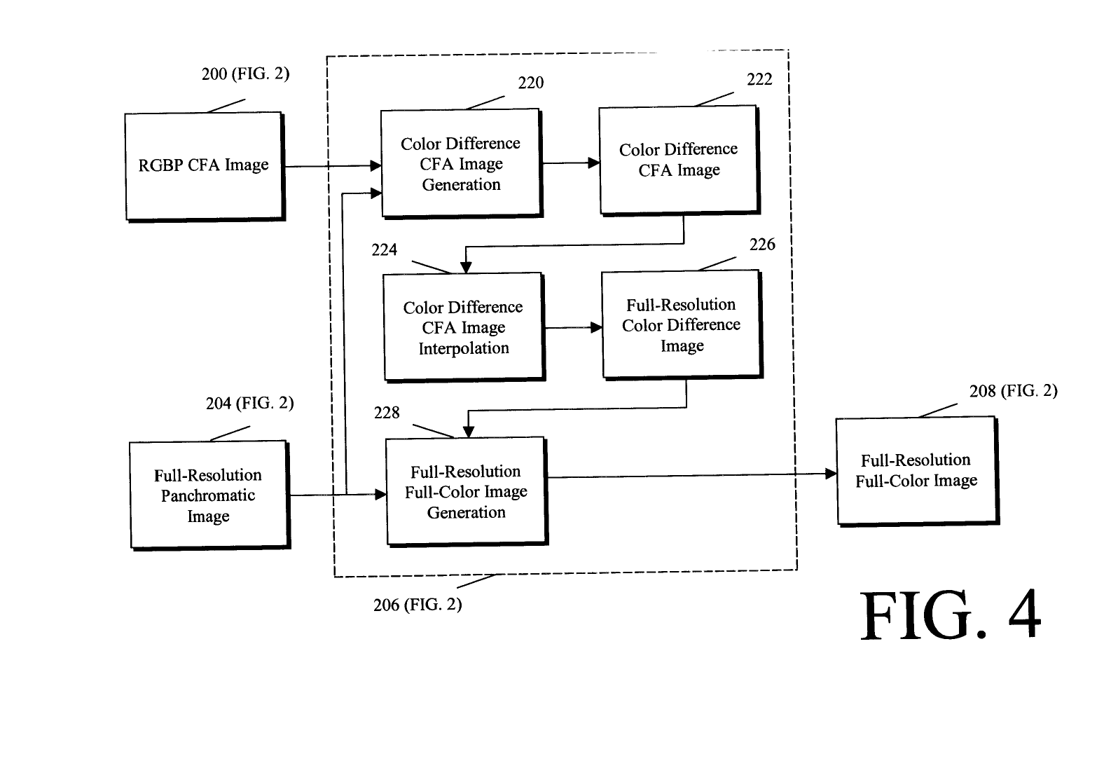

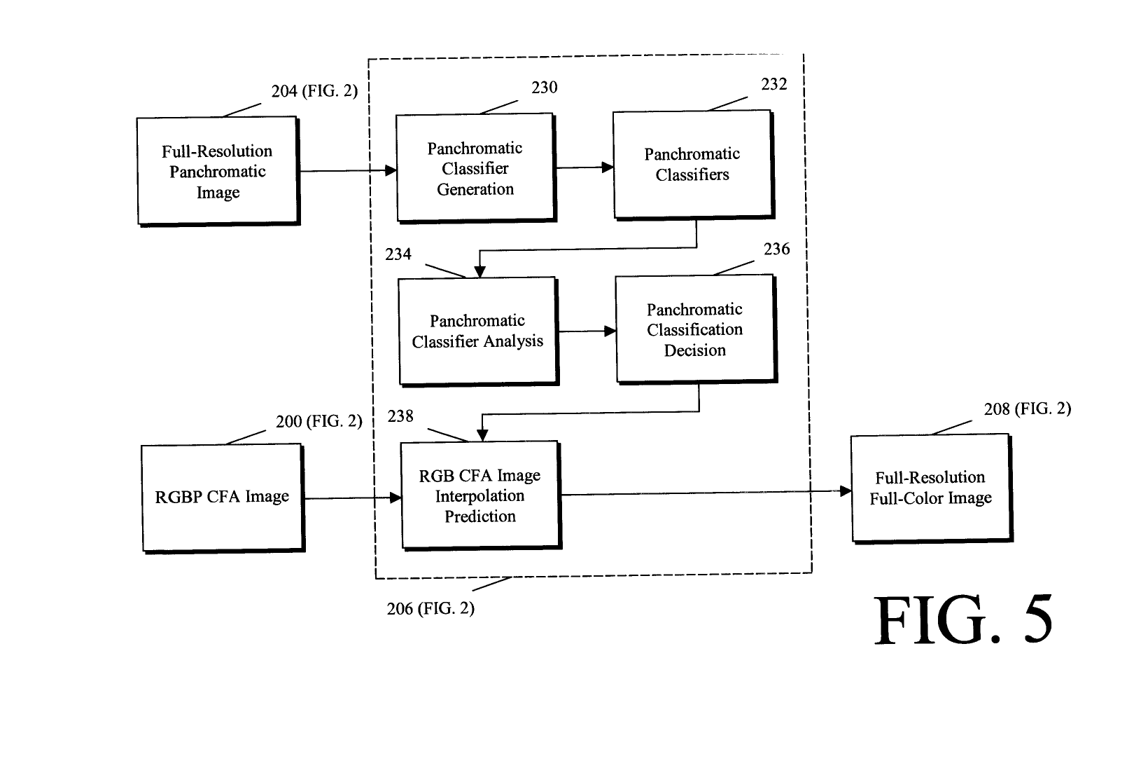

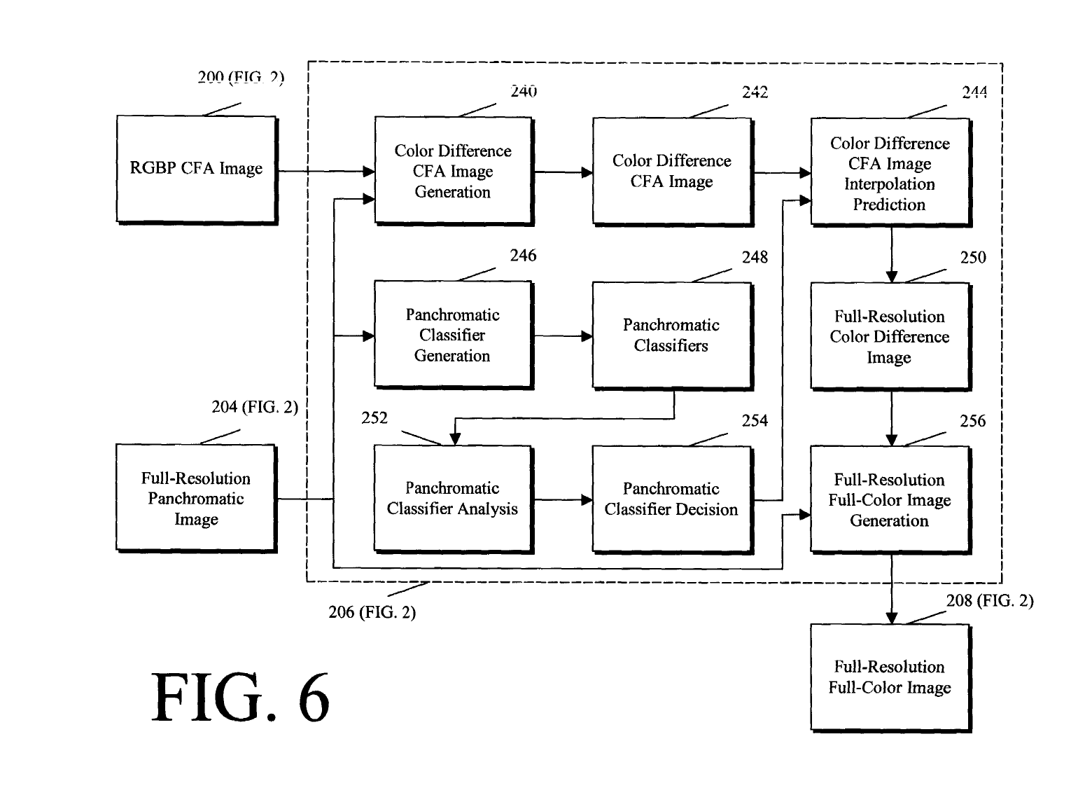

FIG. 2 is a high level diagram of a preferred embodiment. The digital camera 134 is responsible for creating an original digital red-green-blue-panchromatic (RGBP) color filter array (CFA) image 200, also referred to as the digital RGBP CFA image or the RGBP CFA image. It is noted at this point that other color channel combinations, such as cyan-magenta-yellow-panchromatic, can be used in place of red-green-blue-panchromatic in the following description. The key item is the inclusion of a panchromatic channel. This image is considered to be a sparsely sampled image because each pixel in the image contains only one pixel value of red, green, blue, or panchromatic data. A panchromatic image interpolation block 202 produces a full-resolution panchromatic image 204 from the RGBP CFA image 200. At this point in the image processing chain, each color pixel location has an associated panchromatic value and either a red, green, or a blue value. From the RGBP CFA image 200 and the full-resolution panchromatic image 204, an RGB CFA image interpolation block 206 subsequently produces a full-resolution full-color image 208.

In FIG. 2, the panchromatic image interpolation block 202 can be performed in any appropriate way known to those skilled in the art. Two examples are now given. Referring to FIG. 8, one way to estimate a panchromatic value for pixel X₅ is to simply average the surrounding six panchromatic values, i.e.:

X₅=(P₁+P₂+P₃+P₇+P₈+P₉)/6

Alternate weighting to the pixel value in this approach are also well known to those skilled in the art. As an example,

X₅=(P₁+2P₂+P₃+P₇+2P₈+P₉)/8

### Alternately, an adaptive approach can be used by first computing the absolute values of directional gradients (absolute directional gradients).

B₅=|P₁−P₉|

V₅=|P₂−P₈|

S₅=|P₃−P₇|

### The value of X₅ is now determined by one of three two-point averages.

BX₅=(P₁+P₉)/2

VX₅=(P₂+P₈)/2

SX₅=(P₃+P₇)/2

### The two-point average associated with the smallest value of the set of absolute direction gradients is used for computing X₅, e.g., if V₅≦B₅ and V₅≦S₅, then X₅=VX₅.

FIG. 3 is a more detailed view of block 206 (FIG. 2) of the preferred embodiment. The panchromatic correction generation block 210 takes the full-resolution panchromatic image 204 (FIG. 2) and produces a panchromatic correction 214. The low-resolution RGB CFA image interpolation block 212 takes the RGBP CFA Image 200 (FIG. 2) and produces a low-resolution full-color image 216. The image combination block 218 combines the panchromatic correction 214 and the low-resolution full-color image 216 to produce a full-resolution full-color image 208 (FIG. 2).

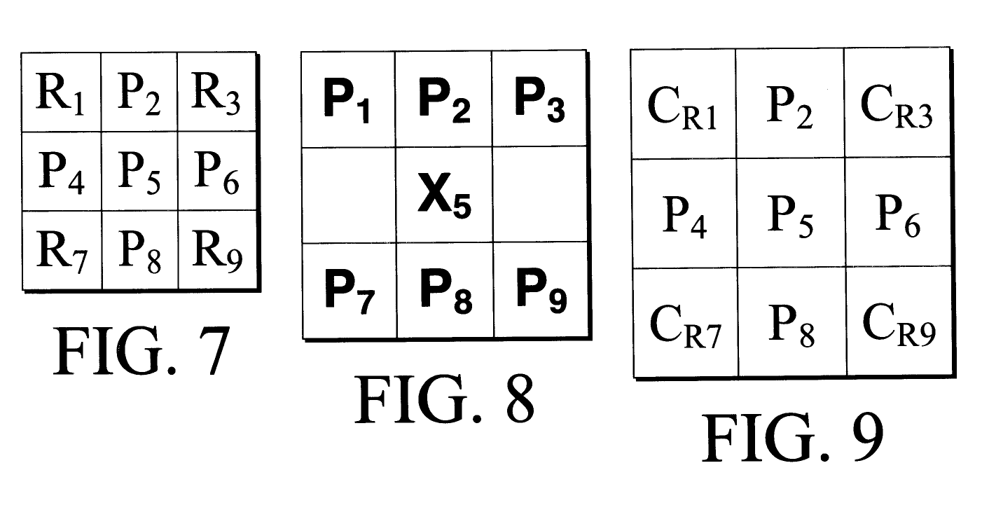

In FIG. 3, the panchromatic correction generation block 206 can be performed in any appropriate way known to those skilled in the art. Referring to FIG. 7, one way to estimate a panchromatic correction value P_{C} for pixel P₅ is to compute a two-dimensional laplacian using the central pixel value and the pixel values coincident with the red pixels in the neighborhood:

P_{C}=(4P₅−P₁−P₃−P₇−P₉)/4

Again, in FIG. 3, the low-resolution RGB CFA image interpolation block 212 can be performed in any appropriate way known to those skilled in the art. Referring to FIG. 7, one way to compute the low-resolution red pixel value R_{L} for pixel P₅ is to compute a four-point average of the red pixels in the neighborhood:

R_{L}=(R₁+R₃+R₇+R₉)/4

Again, in FIG. 3, the image combination block 218 can be performed in any appropriate way known to those skilled in the art. Referring to FIG. 7, one way to compute the full-resolution red pixel value R_{F} for pixel P₅ is to sum the low-resolution red pixel value with the panchromatic correction value in a scaled manner:

R_{F}=R_{L}+kP_{C}

where the scale factor k is nominally one (1), but can be any value from minus infinity to plus infinity. For different colors, such as green and blue, similar computations will be performed. The operations within block 206 (FIG. 2) for this embodiment are performed for every pixel in the image. The resulting full-resolution full-color image 208 (FIG. 2) will consist of R, G, and B at every pixel location.

FIG. 4 is a more detailed view of block 206 (FIG. 2) of an alternate embodiment. The color difference CFA image generation block 220 takes the full-resolution panchromatic image 204 (FIG. 2) and the RGBP CFA image 200 (FIG. 2) and produces a color difference CFA image 222. A color difference CFA image interpolation block 224 takes the color difference CFA image 222 and produces a full-resolution color difference image 226. A full-resolution full-color image generation block 228 combines the full-resolution color difference image 226 and the full-resolution panchromatic image 204 (FIG. 2) to produce a full-resolution full-color image 208 (FIG. 2).

In FIG. 4, the color difference CFA image generation block 220 can be performed in any appropriate way known to those skilled in the art. Referring to FIG. 7, one way is to compute at each color pixel location the difference between color value and the panchromatic value. In FIG. 7, the following computations would be performed:

C_{R1}=R₁−P₁

C_{R3}=R₃−P₃

C_{R7}=R₇−P₇

C_{R9}=R₉−P₉

The values C_{R1}, C_{R3}, C_{R7}, and C_{R9} are the resulting color differences as illustrated in FIG. 9. This operation is performed for every color pixel in the image. The resulting color difference CFA image 222 (FIG. 4) will consist of C_{R}, C_{G}, C_{B}, and P pixel values.

Returning to FIG. 4, the color difference CFA image interpolation block 224 can be performed in any appropriate way known to those skilled in the art. Referring to FIG. 9, one way is to compute the average of the neighboring color difference values to produce a color difference C_{R5} for pixel P₅:

C_{R5}=(C_{R1}+C_{R3}+C_{R7}+C_{R9})/4

### This operation is performed for every pixel in the image and for every color difference channel, C_{R}, C_{G}, and C_{B}. The resulting full-resolution color difference image 226 (FIG. 4) will consist of C_{R}, C_{G}, C_{B}, and P pixel values at every pixel location.

Returning to FIG. 4, the full-resolution full-color image generation block 228 can be performed in any appropriate way known to those skilled in the art. One way is to compute the sums of the color difference values and panchromatic values at each pixel location. If a given pixel has color difference values C_{R}, C_{G}, and C_{B}, and a panchromatic value P, then the corresponding color values R, G, and B would be:

R=C_{R}+P

G=C_{G}+P

B=C_{B}+P

The operations within block 206 (FIG. 2) for this embodiment are performed for every pixel in the image. The resulting full-resolution full-color image 208 (FIG. 2) will consist of R, G, and B at every pixel location.

FIG. 5 is a more detailed view of block 206 (FIG. 2) of an alternate embodiment. A panchromatic classifier generation block 230 takes the full-resolution panchromatic image 204 (FIG. 2) and produces panchromatic classifiers 232. A panchromatic classifier analysis block 234 takes the panchromatic classifiers 232 and produces a panchromatic classification decision 236. A RGB CFA image interpolation prediction block 238 uses the panchromatic classification decision 236 to operate on the RGBP CFA image 200 (FIG. 2) to produce a full-resolution full-color image 208 (FIG. 2).

In FIG. 5, the panchromatic classifier generation block 230 can be performed in any appropriate way known to those skilled in the art. Three examples are now given. The first example uses directional gradients and laplacians. Referring to FIG. 7, a slash classifier, S₅, and a backslash classifier, B₅, for the central pixel in the neighborhood, P₅, can be computed using the following expressions:

G_{S5}=|P₃−P₇|

G_{B5}=|P₁−P₉|

L_{S5}=|2P₅−P₃−P₇|

L_{B5}=|2P₅−P₁−P₉|

S₅=aG_{S5}+bL_{S5}

B₅=aG_{B5}+bL_{B5}

G_{S5} is a slash gradient and G_{B5} is a backslash gradient for pixel P₅. L_{S5} is a slash laplacian and L_{B5} is a backslash laplacian for pixel P₅. The coefficients a and b are used to tune how much of each gradient and laplacian component goes into the final classifier computation. Typical values for a and b are a=1, b=0 for a gradient-only classifier, a=0, b=1 for a laplacian-only classifier, and a=1, b=1 for a combined gradient-and-laplacian classifier. Another example uses directional median filters. Again referring to FIG. 7, a slash classifier, S₅, and a backslash classifier, B₅, for the central pixel in the neighborhood, P₅, can be computed using the following expressions:

M_{S5}=median (P₃, P₅, P₇)

M_{B5}=median (P₁, P₅, P₉)

S₅=|M_{S5}−P₅|

B₅=|M_{B5}−P₅|

M_{S5} is the statistical median of the three panchromatic values P₃, P₅, and P₇. M_{B5} is the statistical median of the three panchromatic values P₁, P₅, and P₉. The third example uses sigma filtering which is a subclass of bilateral filtering. In this case, we compute four classifiers d₁, d₃, d₇, and d₉, which correspond to pixels R₁, R₃, R₇, and R₉:

d₁=|P₁−P₅|

d₃=|P₃−P₅|

d₇=|P₇−P₅|

d₉=|P₉−P₅|

In FIG. 5, the panchromatic classifier analysis block 234 can be performed in any appropriate way known to those skilled in the art. The three examples of the previous paragraph are continued. In the case of the directional gradients and laplacians as well as the case of the directional medians, the analysis of panchromatic classifier block 234 is to determine the smaller of the two values S₅ and B₅ to produce the panchromatic classification decision 236. If S₅≦B₅, then the panchromatic classification decision is slash. Otherwise, the panchromatic classification decision is backslash. In the case of the sigma filter, the analysis of panchromatic classifier block 234 is to determine the values of the four coefficients, c₁, c₃, c₇, and c₉, using the expressions below to produce the panchromatic classification decision:

c₁=1 if d₁<t, otherwise c₁=0

c₃=1 if d₃<t, otherwise c₃=0

c₇=1 if d₇<t, otherwise c₇=0

c₉=1 if d₉<t, otherwise c₉=0

The threshold value, t, is a function of the inherent noisiness of the image capture device. Classically, this noise is modeled as a Gaussian (normal) distribution with an associated mean and standard deviation. The value t is typically set to a value between 1 and 3 times the standard deviation of this noise model.

In FIG. 5, the RGB CFA image interpolation block 238 can be performed in any appropriate way known to those skilled in the art. The three examples of the previous two paragraphs are continued. In the case of the directional gradients and laplacians as well as the case of the directional medians, the panchromatic classification decision 236 is used to select from two prediction values, R_{S5} and R_{B5}:

R_{S5}=(R₃+R₇)/2+k(2P₅−P₃−P₇)/2

R_{B5}=(R₁+R₉)/2+k(2P₅−P₁−P₉)/2

The scale factor k is nominally one (1), but can be any value from minus infinity to plus infinity. If the panchromatic classification decision is slash, then the color value R₅ for pixel P₅ is computed as R_{S5}. Otherwise, it is computed as R_{B5}. In the case of the sigma filter a single prediction value responsive to c₁, c₃, c₇, and c₉ is computed:

R₅={(c₁R₁+c₃R₃+c₇R₇+c₉R₉)+k[(c₁+c₃+c₇+c₉)P₅−c₁P₁−

c₃P₃−c₇P₇−c₉P₉]}/(c₁+c₃+c₇+c₉)

From the above equation, we can see that for pixel P₅ we compute a red pixel value R₅ from the coefficients c₁, c₃, c₇, and c₉ of the classifier decision and from existing red and panchromatic pixel values R₁, R₃, R₇, R₉, P₅, P₁, P₃, P₇, and P₉. The scale factor k is nominally one (1), but can be any value from minus infinity to plus infinity. For different colors, such as green and blue, similar computations will be performed.

Taking every possible combination of values for c₁, c₃, c₇, and c₉, this amounts to selecting one of 16 possible predictor values. The operations within block 206 (FIG. 2) for this embodiment are performed for every pixel in the image. The resulting full-resolution full-color image 208 (FIG. 2) will consist of R, G, and B at every pixel location.

FIG. 6 is a more detailed view of block 206 (FIG. 2) of an alternate embodiment. A color difference CFA image generation block 240 takes the full-resolution panchromatic image 204 (FIG. 2) and the RGBP CFA image 200 (FIG. 2) and produces a color difference CFA image 242. A panchromatic classifier generation block 246 takes the full-resolution panchromatic image 204 (FIG. 2) and produces panchromatic classifiers 248. A panchromatic classifier analysis block 252 takes the panchromatic classifiers 248 and produces a panchromatic classification decision 254. A color difference CFA image interpolation prediction block 244 uses the panchromatic classification decision 254 to operate on the color difference CFA image 242 to produce a full-resolution color difference image 250. A full-resolution full-color image generation block 256 uses the full-resolution color difference image 250 and the full-resolution panchromatic image 204 (FIG. 2) to produce a full-resolution full-color image 208 (FIG. 2).

In FIG. 6, the color difference CFA image generation block 240 can be performed in any appropriate way known to those skilled in the art. Referring to FIG. 7, one way is to compute at each color pixel location the difference between color value and the panchromatic value. In FIG. 7, the following computations would be performed:

C_{R1}=R₁−P₁

C_{R3}=R₃−P₃

C_{R7}=R₇−P₇

C_{R9}=R₉−P₉

The values C_{R1}, C_{R3}, C_{R7}, and C_{R9} are the resulting color differences as illustrated in FIG. 9. This operation is performed for every color pixel in the image. The resulting color difference CFA image 242 (FIG. 6) will consist of C_{R}, C_{G}, C_{B}, and P pixel values.

In FIG. 6, the panchromatic classifier generation block 246 can be performed in any appropriate way known to those skilled in the art. Three examples are now given. The first example uses directional gradients and laplacians. Referring to FIG. 7, a slash classifier, S₅, and a backslash classifier, B₅, for the central pixel in the neighborhood, P₅, can be computed using the following expressions:

G_{S5}=|P₃−P₇|

G_{B5}=|P₁−P₉|

L_{S5}=|2P₅−P₃−P₇|

L_{B5}=|2P₅−P₁−P₉|

S₅=aG_{S5}+bL_{S5}

B₅=aG_{B5}+bL_{B5}

G_{S5} is a slash gradient and G_{B5} is a backslash gradient for pixel P₅. L_{S5} is a slash laplacian and L_{B5} is a backslash laplacian for pixel P₅. The coefficients a and b are used to tune how much of each gradient and laplacian component goes into the final classifier computation. Typical values for a and b are a=1, b=0 for a gradient-only classifier, a=0, b=1 for a laplacian-only classifier, and a=1, b=1 for a combined gradient-and-laplacian classifier. Another example uses directional median filters. Again referring to FIG. 7, a slash classifier, S₅, and a backslash classifier, B₅, for the central pixel in the neighborhood, P₅, can be computed using the following expressions:

M_{S5}=median (P₃, P₅, P₇)

M_{B5}=median (P₁, P₅, P₉)

S₅=|M_{S5}−P₅|

B₅=|M_{B5}−P₅|

M_{S5} is the statistical median of the three panchromatic values P₃, P₅, and P₇. M_{B5} is the statistical median of the three panchromatic values P₁, P₅, and P₉. The third example uses sigma filtering which is a subclass of bilateral filtering. In this case, we compute four classifiers d₁, d₃, d₇, and d₉, which correspond to pixels R₁, R₃, R₇, and R₉:

d₁=|P₁−P₅|

d₃=|P₃−P₅|

d₇=|P₇−P₅|

d₉=|P₉−P₅|

In FIG. 6, the panchromatic classifier analysis block 252 can be performed in any appropriate way known to those skilled in the art. The three examples of the previous paragraph are continued. In the case of the directional gradients and laplacians as well as the case of the directional medians, the analysis of panchromatic classifier analysis block 252 is to determine the smaller of the two values S₅ and B₅ to produce the panchromatic classification decision 254. If S₅≦B₅, then the panchromatic classification decision is slash. Otherwise, the panchromatic classification decision is backslash. In the case of the sigma filter, four coefficients, c₁, c₃, c₇, and c₉, together constitute the panchromatic classification decision:

c₁=1 if d₁<t, otherwise c₁=0

c₃=1 if d₃<t, otherwise c₃=0

c₇=1 if d₇<t, otherwise c₇=0

c₉=1 if d₉<t, otherwise c₉=0

The threshold value, t, is a function of the inherent noisiness of the image capture device. Classically, this noise is modeled as a Gaussian (normal) distribution with an associated mean and standard deviation. The value t is typically set to a value between 1 and 3 times the standard deviation of this noise model.

In FIG. 6, the color difference CFA image interpolation prediction block 244 can be performed in any appropriate way known to those skilled in the art. The three examples of the previous two paragraphs are continued. In the case of the directional gradients and laplacians as well as the case of the directional medians, the panchromatic classification decision 254 is used to select from two prediction values, C_{S5} and C_{B5}:

C_{S5}=(C₃+C₇)/2

C_{B5}=(C₁+C₉)/2

If the panchromatic classification decision is slash, then the color difference value C₅ for pixel P₅ is computed as C_{S5}. Otherwise, it is computed as C_{B5}. In the case of the sigma filter a single prediction value responsive to c₁, c₃, c₇, and c₉ is computed:

C₅=(c₁C₁+c₃C₃+c₇C₇+c₉C₉)/(c₁+c₃+c₇+c₉)

From the above equation, we can see that for pixel P₅ we compute a color difference value C₅ from the coefficients c₁, c₃, c₇, and c₉ of the classifier decision and from existing color difference values and panchromatic pixel values C₁, C₃, C₇, and C₉. The scale factor k is nominally one (1), but can be any value from minus infinity to plus infinity.

Taking every possible combination of values for c₁, c₃, c₇, and c₉, this amounts to selecting one of 16 possible predictor values. The resulting full-resolution color difference image 250 will consist of C_{R}, C_{G}, C_{B}, and P pixel values at every pixel location.

Returning to FIG. 6, the full-resolution full-color image generation block 256 can be performed in any appropriate way known to those skilled in the art. One way is to compute the sums of the color difference values and panchromatic values at each pixel location. If a given pixel has color difference values C_{R}, C_{G}, and C_{B}, and a panchromatic value P, then the corresponding color values R, G, and B would be:

R=C_{R}+P

G=C_{G}+P

B=C_{B}+P

The operations within block 206 (FIG. 2) for this embodiment are performed for every pixel in the image. The resulting full-resolution full-color image 208 (FIG. 2) will consist of R, G, and B at every pixel location.

The interpolation algorithms disclosed in the preferred embodiments of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the interpolation algorithms can stand alone or can be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithms themselves can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the algorithms can interface with a variety of workflow user interface schemes.

The interpolation algorithms disclosed herein in accordance with the invention can have interior components that utilize various data detection and reduction techniques (e.g., face detection, eye detection, skin detection, flash detection).

The invention has been described in detail with particular reference to certain preferred embodiments thereof, but it will be understood that variations and modifications can be effected within the spirit and scope of the invention.

### Parts List

110 Computer System
112 Microprocessor-based Unit
114 Display
116 Keyboard
118 Mouse
120 Selector on Display
122 Disk Drive Unit
124 Compact Disk-read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection
200 RGBP CFA Image
202 Panchromatic Image Interpolation
204 Full-Resolution Panchromatic Image
206 RGB CFA Image Interpolation
208 Full-Resolution Full-Color Image
210 Panchromatic Correction Generation
212 Low-Resolution RGB CFA Image Interpolation
214 Panchromatic Correction
216 Low-Resolution Full-Color Image
218 Image Combination
220 Color Difference CFA Image Generation
222 Color Difference CFA Image
224 Color Difference CFA Image Interpolation
226 Full-Resolution Color Difference Image
228 Full-Resolution Full-Color Image Generation
230 Panchromatic Classifier Generation
232 Panchromatic Classifiers
234 Panchromatic Classifier Analysis
236 Panchromatic Classification Decision
238 RGB CFA Image Interpolation Prediction
240 Color Difference CFA Image Generation
242 Color Difference CFA Image
244 Color Difference CFA Image Interpolation Prediction
246 Panchromatic Classifier Generation
248 Panchromatic Classifiers
250 Full-Resolution Color Difference Image
252 Panchromatic Classifier Analysis
254 Panchromatic Classifier Decision
256 Full-Resolution Full-Color Image Generation

1. A method for forming a digital color image of a desired resolution, comprising:
(a) providing a panchromatic image of a scene having a first resolution at least equal to the desired resolution and a first color image having at least two different color photoresponses, the first color image having a lower resolution than the desired resolution; and
(b) using the color pixel values from the first color image and the panchromatic pixel values to provide additional color pixels and combining the additional color pixels with the first color image to produce the digital color image having the desired resolution.

2. The method of claim 1 wherein step (b) includes using color differences between the pixel values of the first color image and pixel values of the panchromatic image.

3. The method of claim 1 wherein the value of at least two panchromatic pixels are used to determine the color pixel value of each additional color pixel to be added to the first digital color image.

4. The method of claim 3 wherein at least one of the values of the panchromatic pixels is coincident with the position of the additional color pixel.

5. The method of claim 3 wherein the differences between at least two panchromatic pixel values and the values of neighboring color pixels are combined to form the additional pixel.

6. The method of claim 1 further including an image sensor with color and panchromatic pixels that produces a captured panchromatic and a captured color image of a scene and interpolates the captured panchromatic image to produce the first panchromatic image that has a higher resolution than the captured panchromatic image.

7. The method of claim 1 further including an image sensor with color and panchromatic pixels that produces a captured panchromatic and a captured color image of a scene and interpolates the captured color image to produce the first color image that has a higher resolution than the captured color image.

8. A method for forming a digital color image of a desired resolution, comprising:
(a) capturing an image of a scene using an image sensor having panchromatic pixels and color pixels corresponding to at least two color photoresponses providing a panchromatic image of the scene having a first resolution at least equal to the desired resolution and a first color image having at least two different color photoresponses, the first color image having a lower resolution than the desired resolution; and
(b) using the color pixel values from the first color image and the panchromatic pixel values to provide additional color pixels and combining the additional color pixels with the first color image to produce the digital color image having the desired resolution.

9. The method of claim 8 wherein step (b) includes using color differences between the pixel values of the first color image and pixel values of the panchromatic image.

10. The method of claim 8 wherein the value of at least two panchromatic pixels are used to determine the color pixel value of each additional color pixel to be added to the first digital color image.

11. The method of claim 8 wherein at least one of the values of the panchromatic pixels is coincident with the position of the additional color pixel.

12. The method of claim 8 wherein the differences between at least two panchromatic pixel values and the values of neighboring color pixels are combined to form the additional pixel.

13. A method for forming a digital color image of a desired resolution, comprising:
(a) providing a panchromatic image of a scene having a first resolution at least equal to the desired resolution and a first color image having at least two different color photoresponses, the first color image having a lower resolution than the desired resolution;
(b) using the first panchromatic pixel values to provide classifiers; and
(c) using the classifiers and color pixel values from the first color image and panchromatic pixel values to provide additional color pixels and combining the additional color pixels with the first color image to produce the digital color image having the desired resolution.

14. A method for forming a digital color difference image having a higher resolution than a provided color difference image, comprising:
(a) providing a panchromatic image of a scene having a first resolution at least equal to the desired resolution and the lower-resolution color difference image having at least two different color differences, the color difference image having a lower resolution than the desired resolution;
(b) using the first panchromatic pixel values to provide classifiers; and
(c) using the classifiers and the color difference values from the lower-resolution color difference image and panchromatic pixel values to provide additional color difference values and combining the additional color difference values with the color difference image to produce the digital color difference image having the higher resolution.

15. A method of forming a full-resolution color image, comprising:
(a) forming the lower-resolution color difference image of claim 14 in response to the pixel values of an original captured color image and the panchromatic image;
(b) using the method of claim 14 to produce the higher-resolution color difference image; and
(c) using the panchromatic pixel values and the higher-resolution color difference image to provide a full-resolution color image.
